(19) United States
(12) Patent Application Publication
(10) Pub. No.: US 2017/0324157 A1
(43) Pub. Date: Nov. 9, 2017

(54) THREE PIECE VEHICLE RADOME

(71) Applicant: SRG Global Inc., Warren, MI (US)

(72) Inventors: James Michael Shurish, Casco, MI (US); Nicholas Bruyneel, Ortonville, MI (US); Rob Frayer, Huntington Woods, MI (US); Kurt Meier, Shelby Township, MI (US)

(73) Assignee: SRG Global Inc., Warren, MI (US)

(21) Appl. No.: 15/145,495

(22) Filed: May 3, 2016

(51) Int. Cl. H01Q 1/42; H01Q 1/32

(52) U.S. Cl. CPC H01Q 1/42; H01Q 1/32

(57) ABSTRACT

A radome for a vehicle can include a cover piece formed of a first resin that is transparent and defining a back surface that defines one of a first recess and a first protrusion. The radome can include an intermediate piece formed of a second resin defining a front surface that is coated with a metalloid and that defines the other of the first recess and the first protrusion. The radome can further include a back piece formed of a third resin that is non-transparent and defining a top surface that defines one of a second recess and a second protrusion configured to be mated with at least a portion of at least one of the intermediate piece and the cover piece. Manufacturing the radome can involve using three different molds for forming the cover, intermediate, and back pieces, and applying the metalloid coating.

### FIELD

The present disclosure generally relates to radomes for vehicles and, more particularly, to a three piece vehicle radome.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A radar cover or “radome” is a structure or enclosure that protects a radar device (e.g., a radar antenna). For vehicle applications, radar devices can be used for object proximity monitoring, such as in adaptive cruise control systems and other similar systems (e.g., parking assistance systems). For optimal performance of the radar device, the radome should be constructed of material that minimally attenuates electromagnetic signals that are transmitted and received by the radar device. For vehicle applications, the radome is often visible (e.g., mounted to an external surface of the vehicle) and therefore should also be visually appealing. Complex designs and metal coatings, however, can substantially increase radome costs.

### SUMMARY

According to a first aspect of the present disclosure, a radome is presented.

In one exemplary implementation, the radome can include a cover piece formed of a first resin that is transparent, the cover piece defining a back surface that defines one of a first recess and a first protrusion; an intermediate piece formed of a second resin, the intermediate piece defining a front surface that is coated with a metalloid and that defines the other of the first recess and the first protrusion, wherein the first recess and the first protrusion are configured to mate the cover piece and the intermediate piece; and a back piece formed of a third resin that is non-transparent, the back piece defining a front surface that defines one of a second recess and a second protrusion, wherein the second recess or the second protrusion is configured to be mated with at least a portion of at least one of the intermediate piece and the cover piece.

In some implementations, the cover, intermediate, and back pieces are all injection molded. In some implementations, the back piece is injection molded using a mold with the cover and intermediate pieces inserted therein. In other implementations, the cover piece is injection molded using a mold with the back and intermediate pieces inserted therein.

In some implementations, the metalloid coating is applied by physical vapor deposition (PVD). In some implementations, the metalloid comprises silicon. In some implementations, the back piece defines an outer edge portion that defines a thickness that is greater than a thickness defined by a center portion of the back piece. In some implementations, the back piece further defines a mounting feature configured to attach the radome to a front end of to the vehicle.

In some implementations, a particular surface of at least one of the cover, intermediate, and back pieces has a color or a multi-colored graphic applied thereto using a paint or by hot stamping of a film. In some implementations, at least one of (i) the first recess, (ii) the first protrusion, and (iii) the second recess or second protrusion corresponds to a symbol associated with a brand of the vehicle.

According to a second aspect of the present disclosure, a method of manufacturing a radome for a vehicle is presented. In one exemplary implementation, the method can include using a first mold, molding a first resin to form a cover piece defining a back surface that defines one of a first recess and a first protrusion, the first resin being transparent; using a second mold, molding a second resin to form an intermediate piece defining a front surface that defines the other of the first recess and the first protrusion, wherein the first recess and the first protrusion are configured to mate the cover piece and the intermediate piece; coating the front surface of the intermediate piece with a metalloid; using the third mold, molding a third resin to form a back piece defining a front surface that defines one of a second recess and a second, the third resin being non-transparent, wherein the second recess or the second protrusion is configured to be mated with at least a first portion of at least one of the intermediate piece and the cover piece; and forming the radome by mating the cover, intermediate, and back pieces.

In some implementations, the method further comprises inserting the cover and intermediate pieces into the third mold prior to molding the third resin. In some implementations, molding the third resin to form the back piece includes overmolding a portion of the back piece to form an overmolded edge configured to mate with at least a second portion of at least one of the intermediate piece and the cover piece.

In other implementations, the method further comprises inserting the intermediate and back pieces into the first mold prior to molding the first resin. In some implementations, molding the first resin to form the cover piece includes overmolding a portion of the cover piece to form an overmolded edge configured to mate with at least a portion of at least one of the intermediate piece and the back piece.

In some implementations, the metalloid comprises silicon. In some implementations, coating the front surface of the intermediate piece with the metalloid includes using physical vapor deposition (PVD). In some implementations, at least one of (i) the first recess, (ii) the first protrusion, and (iii) the second recess or second protrusion corresponds to a symbol associated with a brand of the vehicle.

In some implementations, the back piece defines an outer edge that defines a thickness that is greater than a thickness defined by a center portion of the back piece. In some implementations, the method further comprises applying a color or a multi-colored graphic to a particular surface of at least one of the cover, intermediate, and back pieces by using a paint or by hot stamping of a film.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a bottom exploded view of an example three piece vehicle radome according to some implementations of the present disclosure;

FIG. 1B is a top exploded view of the example radome of FIG. 1

FIG. 2 is a perspective view of the example radome of FIG. 1A;

FIG. 3 is a side view of the example radome of FIG. 1A;

FIGS. 4A-4B are partial side views of two configurations of an edge portion of the example radome of FIG. 2; and

FIG. 5 is a flow diagram of a process for manufacturing a three piece vehicle radome according to some implementations of the present disclosure.

### DETAILED DESCRIPTION

As previously mentioned, conventional radomes can be costly to manufacture. In particular, decorative metal coatings (e.g., for accenting designs, such as a vehicle's brand symbol) can be expensive. Accordingly, an improved three piece vehicle radome and a method of manufacturing a three piece vehicle radome are presented. The radome is a three piece assembly comprising a cover piece, an intermediate piece, and a back piece. When mated together, the three pieces form the radome, with the cover piece being arranged furthest from a radar device of a vehicle and the back piece being arranged nearest the radar device. The cover piece can be molded (e.g., injection molded) from a first resin that is transparent. A back surface of the cover piece can define a first feature (“one of a first recess and a first protrusion”). The intermediate piece can be molded (e.g., injection molded) from a second resin that can be transparent or non-transparent. A front surface of the intermediate piece can be coated with a metalloid (e.g., comprising silicon) and can define a second feature (“the other of the first recess and the first protrusion”). The first and second features can be at least partially complimentary. That is, the first protrusion can at least partially fit within the first recess to mate the cover and intermediate pieces.

The metalloid on the front surface of the intermediate piece can be applied via any suitable physical vapor deposition (PVD) technique. Non-limiting examples of PVD techniques include cathodic arc deposition, electron beam PVD, evaporative deposition, pulsed laser deposition, and sputter deposition. The back piece can be molded (e.g., injection molded) from a third resin that is non-transparent. A front surface of the back piece can define a third feature (“a second recess or second protrusion configured to be mated with at least a portion of at least one of the intermediate piece and the cover piece”). In other words, the third feature is at least partially complimentary to the cover and intermediate pieces. Because the cover layer (and in some cases, the intermediate layer) is transparent, the metalloid coating itself does not appear as metallic. Instead, the metalloid coating appears as more of a tinting (e.g., similar to window tinting). When received by the non-transparent back piece, however, the metalloid coating appears brighter and reflective, similar to a metal. An edge of the back piece or the cover piece can be overmolded over at least a portion of the mated cover/intermediate or intermediate/back pieces to hold the radome together. Alternatively, an adhesive could be utilized. The pieces could also be held together via chemical bonding (e.g., as a result of the heat generated during the molding processes). In some implementations, the back piece can further define a mounting feature configured to attach the radome to a portion (e.g., a front end) of the vehicle.

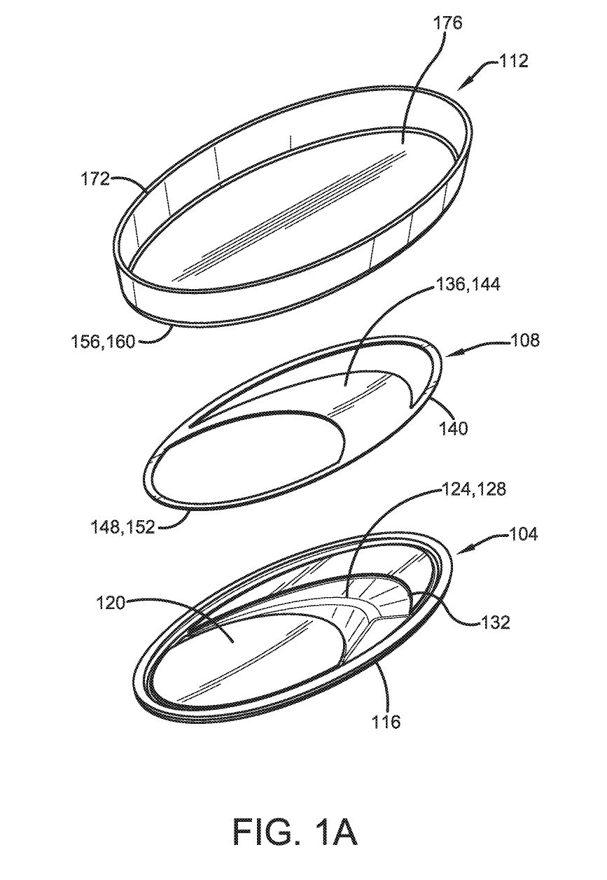

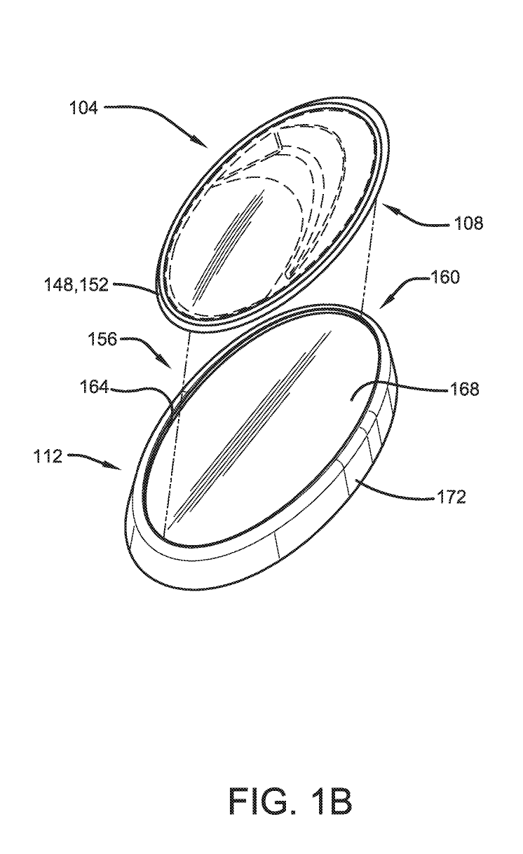

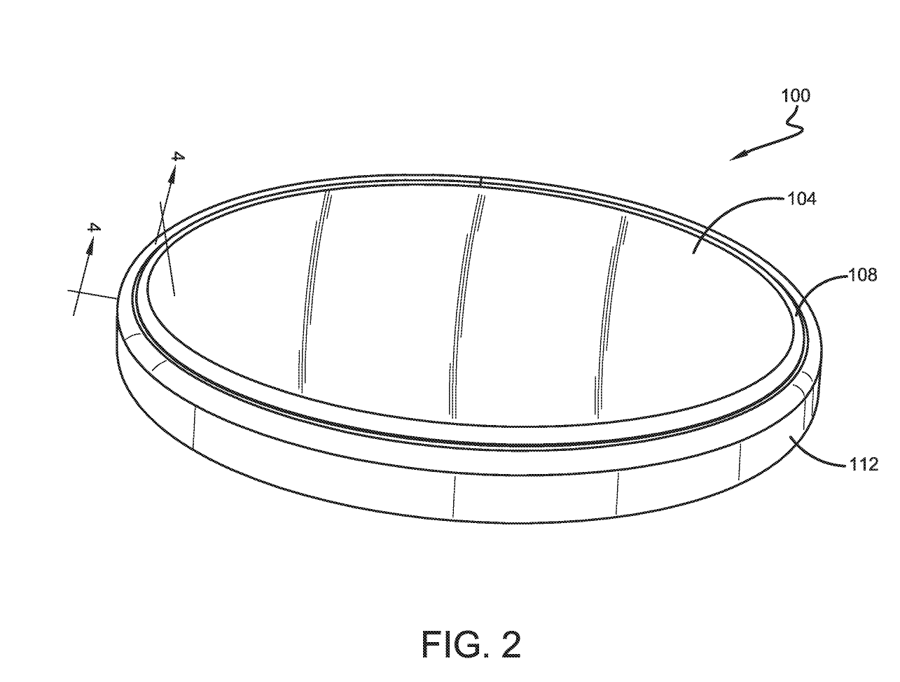

Referring now to FIGS. 1A-1B and 2-3, top/bottom exploded, perspective, and side views of an example radome 100 are illustrated. The three pieces of the radome 100 include a cover piece 104, an intermediate piece 108, and a back piece 112. The cover piece 104 and the intermediate piece 108 can each be formed of a transparent resin, but it will be appreciated that the intermediate piece 108 could also be formed from a non-transparent resin. One example of the transparent resin is a thermoplastic polymer or polycarbonate, but it will be appreciated that other suitable transparent resins could be utilized. The cover piece 104 can be formed using a first mold (e.g., injection molding) and can define a front surface 116 and a back surface 120. The back surface 120 can further define a first recess 124 defining a shape 128 and a depth 132 that at least partially corresponds to the intermediate piece 108. In some implementations, the intermediate piece 108 can define a shape 136 and a depth 140 that corresponds to the shape 128 and the depth 132 of the cover piece 104 such that, when mated, the back surface 120 of the cover piece 104 will be substantially flush with a back surface 144 defined by the intermediate piece 108. Thus, the entire intermediate piece 108 could be a first protrusion that fits in the first recess 124. As previously discussed herein, however, the first recess 124 could be a first protrusion 124.

The intermediate piece 108 can be separately formed using a second mold (e.g., injection molding) and can further define a front surface 148. The shape 136 of the intermediate piece 108 (and thus, the features of the first and second molds) can correspond to a symbol for display on the vehicle. The symbol can correspond to the vehicle's brand and thus could also be described as a logo, emblem, decal, nameplate, and the like. A radar-transparent metalloid 152 can be disposed on at least a portion of the front surface 148 of the intermediate piece 108. For example, the deposition of the metalloid 152 can be for portions of the intermediate piece 108 that are to be accented. This metalloid 152, however, is not a metal. The metalloid 152 can comprise silicon and, in some implementations, other materials (dopants, germanium, etc.). One example of applying the metalloid 152 to the front surface 148 includes PVD of the metalloid 152 onto the front surface 148.

In some implementations, the metalloid 152 can include three total layers: a painted base layer, the deposited metalloid, and a top coat. The top coat could be the portion that faces and mates with the first recess/protrusion 124 of the cover piece 104. Tinting, for example, could be added to either the painted base layer or the top coat in order to adjust the color of the intermediate piece 108 (e.g., when mated with the back piece). When applied to the intermediate piece 108 (or when mated with the cover piece 104), the metalloid 152 may not appear metallic. Instead, the metalloid 152 will appear as a tinting to the intermediate piece 108. (e.g., similar to window tinting). The metalloid 152 can also define different colors. In one implementations, the deposited metalloid portion of the metalloid 152 could be deposited such that it defines a particular thickness in order to appear vary the color and/or brightness/darkness of the metalloid 152 (e.g., when mated with the back piece 112).

The intermediate piece 108 can be mated with the cover piece 104 by inserting the intermediate piece 108 into the first recess 124. Alternatively, when the cover piece 104 defines a first protrusion, the first protrusion can be inserted into a first recess of the intermediate piece 108. While the back surfaces 120, 144 of the cover and intermediate pieces 104, 108 could be fully flush, it will also be appreciated that the intermediate piece 108, when mated with the cover piece 104, could extend beyond the back surface 120 of the cover piece 104. Because these pieces are complimentary and thus can be mated together, a subsequent molding step to form the radome 100 does not require these components to be specifically aligned or held proximate to each other. This simplifies and could potentially reduce costs of the final molding process. The final and third molding step involves using a separate third mold to form the back piece 112. The mated cover and intermediate pieces 104, 108 can be inserted into the third mold for this operation. The back piece 112 can be formed of a non-transparent resin. Two examples of the non-transparent resin are acrylonitrile styrene acrylate (ASA) and acrylonitrile butadiene styrene (ABS) plastics, but it will be appreciated that other non-transparent plastics could be utilized.

The back piece 112 can define a front surface 156 that further defines a second recess 160. The second recess 160 can define a wall surface 164 and a bottom surface 168. As previously mentioned, the back piece 112 can alternatively define a second protrusion instead of the second recess 160. This second protrusion could be configured to be mated with a portion of the intermediate piece 108. The back piece 112 can further define an extended outer edge 172 and a back surface 176. This extended outer edge 172 can define a depth greater than the center portion 168. This extended outer edge 172, for example, can be outside of a field of view of a radar device 180. Thus, the back piece 112 defines a non-uniform thickness. This extended outer edge 172 can be a feature that is configured to be attached to a portion (e.g., a front end) of a vehicle. It will be appreciated, however, that other features coupled to the extending outer edge 172 and/or the back surface 176 could be utilized to attach the radome 100 to the vehicle. Non-limiting examples of these features include brackets and mounting holes. When the pieces 104, 108, 112 are mated together to form the radome 100, the radar device 180 could be positioned behind the back surface 176 of the back piece and could be configured to transmit radar waves through the radome 100 and out the front surface 116 of the cover piece 104 and receive radar waves in an opposing manner.

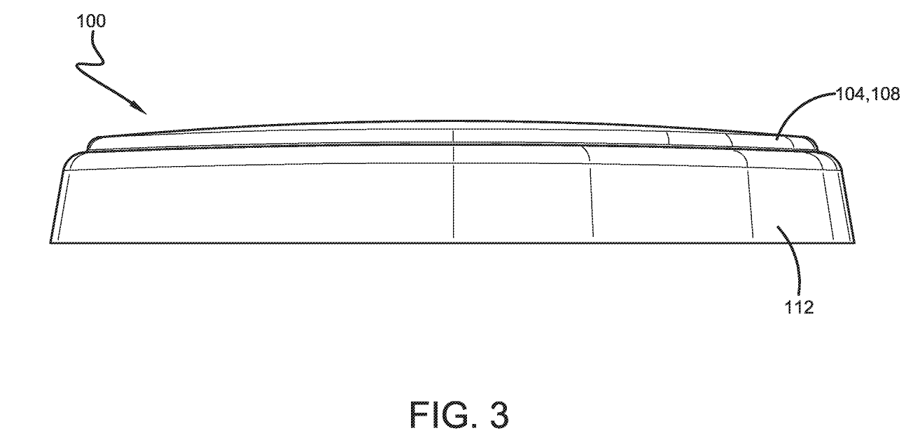

When the mated cover and intermediate pieces 104, 108 are mated with the back piece 112 (i.e., when they are inserted into the second recess 160), the metalloid 152 will appear brighter due to the lack of transparency of the back piece 112. In other words, while the metalloid 152 does not itself appear metallic, it may appear metallic when placed in proximity to the non-transparent back piece 112. As mentioned above, at least a portion 184 of the mated cover and intermediate pieces 104, 108 can be received by the second recess 160 in the front surface 156 of the back piece 112. For example, as shown in the side view of FIG. 3, only the portion of the mated cover and intermediate pieces 104, 108 fits into the second recess 160. In other words, at least some of the mated cover and intermediate pieces 104, 108 can protrude from the second recess 160 when mated with the back piece 112. Different configurations of an edge portion 188 where this portion 184 of the mated cover and intermediate pieces 104, 108 can be utilized in order to hold the radome 100 together as a single unit. Specific examples of these configurations are now discussed in greater detail. It will be appreciated, however, that the pieces 104, 108, 112 can be held together via alternate means, such as chemical bonding caused by heat generated during the molding processes. It will be appreciated that a single color or multi-colored graphic could also be applied to any surface of the pieces 104, 108, 112, such as to further enhance the appearance of the vehicle's brand symbol. This color application could be performed by techniques such as applying a paint (spray, silk screen, etc.), hot stamping a colored or multi-colored film, and the like.

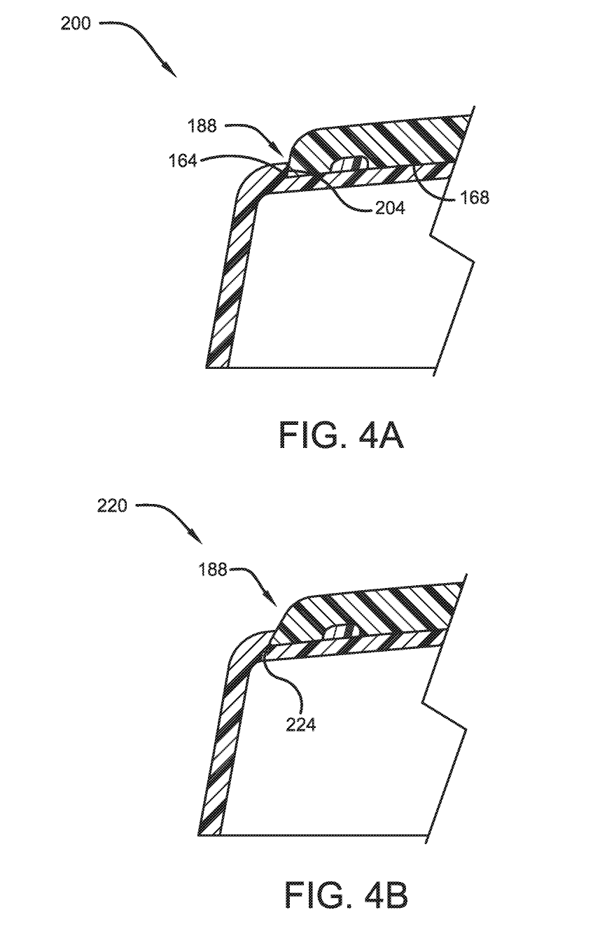

Referring now to FIGS. 4A-4B, two configurations for the edge portion 188 of the radome 100 are illustrated. FIG. 4A illustrates a first example configuration 200 of the edge portion 184, which includes an adhesive 204 disposed between the portion 184 of the mated cover and intermediate pieces 104, 108 and the second recess 160. The adhesive 204 could be disposed on the wall surface 164 of the second recess 160, on the bottom surface 168 of the second recess 160, or some combination thereof. FIG. 4B illustrates a second example configuration 220 of the edge portion 188, which includes an overmolded edge 224. This overmolded edge 224 can be part of the back piece 112 and can be formed during the molding of the back piece 112. For example, the third mold used to create the back piece 112 could define a feature corresponding to the overmolded edge 224. The adhesive 204 and the overmolded edge 224 can each hold the portion 184 of the mated cover and intermediate pieces 104, 108 in the second recess 160, thereby holding all three pieces 104, 108, 112 of the radome 100 together as a unit. In one exemplary implementation, some partial or full combination (e.g., both) of the adhesive 204 and the overmolded edge 224 could be utilized.

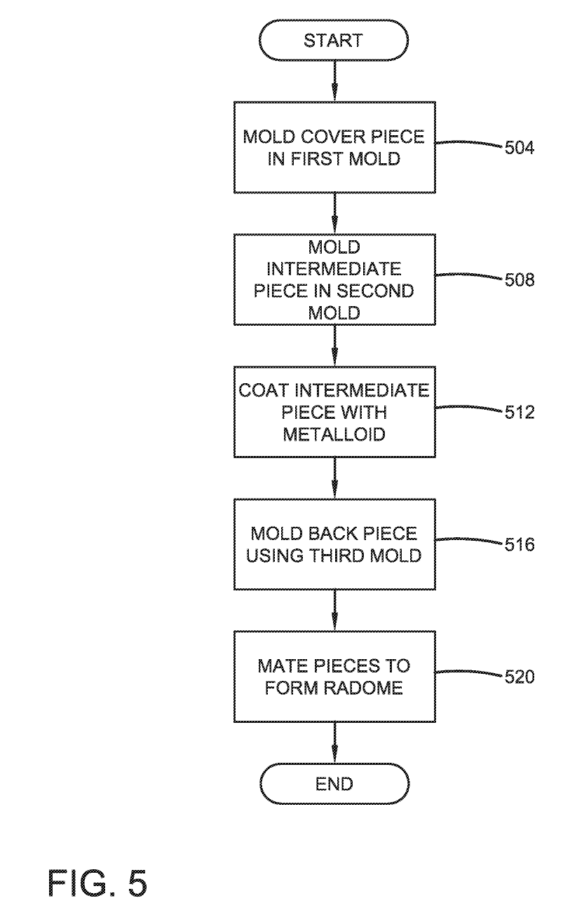

Referring now to FIG. 5, a flow diagram of an example method 500 for manufacturing the radome 100 is illustrated. At 504, using a first mold, a first transparent resin can be molded to form the cover piece 104 defining the back surface 120 and the first recess 124. At 508, using a second mold, a second resin can be molded to form the intermediate piece 108. For example, the front surface 148, the back surface 144, the shape 136 and depth 140 can correspond to the first recess 124 such that, when mated, the back surface 144 of the intermediate piece 108 is substantially flush with the back surface 120 of the cover piece 104. At 512, the front surface 148 of the intermediate piece 108 can be coated with a metalloid 152. One example process for applying this metalloid 152 is PVD of the metalloid 152 onto the front surface 148. At 516, using a third mold, back piece 112 can be formed by molding a third non-transparent resin. For example, the top surface 156can define the second recess 160 for receiving at least the portion 184 the mated cover and intermediate pieces 104, 108. The radome 100 (i.e., at least the portion 184 of the mated cover and intermediate pieces 104, 108 and the back piece 112) can be held together via the adhesive 204 (see FIG. 4A) or an overmolded edge 224 (see FIG. 4B). This overmolded edge 224 can be formed, for example, using the third mold. At 520, the cover, intermediate, and back pieces 104, 108, 112 can be mated to form the complete radome 100. The method 500 can then end or return to 504 to be repeated for manufacturing another radome 100. It will also be appreciated that an order of at least some of these steps can be rearranged as described herein.

While joining of the cover and intermediate pieces 104, 108 followed by their receiving by the second recess 160 of the back piece 112 is discussed herein, it will be appreciated that the radome 100 could be formed using a different process. More particularly, an order of the molding steps and the joining of components could be rearranged. In one exemplary implementation, the second recess 160 of the back piece 112 could be formed to define a shape and corresponding to the intermediate piece 108. These components could then be mated together (e.g., in a separate mold) to form the cover piece 104. In such a configuration, the cover piece 104 may be relatively flat (i.e., no first recess 124 in its back surface 120). In some implementations, the cover piece 104 could be overmolded over an edge of the mated intermediate and back pieces 108, 112 (in the first mold, similar to how the back piece 112 can be overmolded over the portion 184 of the mated cover and intermediate pieces 104, 108 could be inserted into the third mold) or an adhesive (e.g., adhesive 204) could be applied to hold everything together. Chemical/re-melt bonds could also hold the components together. These components could also be physically snapped together or could be loosely held together (e.g., only for the purpose of being easily inserted into another mold without additional attachment/securing devices).

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments. Similarly, method or flowchart steps do not necessarily imply an order of operations (e.g., a step recited after another step could be performed before the other step, unless required as being performed after).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A radome for a vehicle, the radome comprising:
a cover piece formed of a first resin that is transparent, the cover piece defining a back surface that defines one of a first recess and a first protrusion;
an intermediate piece formed of a second resin, the intermediate piece defining a front surface that is coated with a metalloid and that defines the other of the first recess and the first protrusion, wherein the first recess and the first protrusion are configured to mate the cover piece and the intermediate piece; and
a back piece formed of a third resin that is non-transparent, the back piece defining a front surface that defines one of a second recess and a second protrusion, wherein the second recess or the second protrusion is configured to be mated with at least a portion of at least one of the intermediate piece and the cover piece.

2. The radome of claim 1, wherein the cover, intermediate, and back pieces are all injection molded.

3. The radome of claim 2, wherein the back piece is injection molded using a mold with the cover and intermediate pieces inserted therein.

4. The radome of claim 2, wherein the cover piece is injection molded using a mold with the back and intermediate pieces inserted therein.

5. The radome of claim 1, wherein the metalloid coating is applied by physical vapor deposition (PVD).

6. The radome of claim 1, wherein the metalloid comprises silicon.

7. The radome of claim 1, wherein the back piece defines an outer edge portion that defines a thickness that is greater than a thickness defined by a center portion of the back piece.

8. The radome of claim 1, wherein a particular surface of at least one of the cover, intermediate, and back pieces has a color or a multi-colored graphic applied thereto using a paint or by hot stamping of a film.

9. The radome of claim 1, wherein at least one of (i) the first recess, (ii) the first protrusion, and (iii) the second recess or second protrusion corresponds to a symbol associated with a brand of the vehicle.

10. The radome of claim 1, wherein the back piece further defines a mounting feature configured to attach the radome to a front end of to the vehicle.

11. A method of manufacturing a radome for a vehicle, the method comprising:
using a first mold, molding a first resin to form a cover piece defining a back surface that defines one of a first recess and a first protrusion, the first resin being transparent;
using a second mold, molding a second resin to form an intermediate piece defining a front surface that defines the other of the first recess and the first protrusion, wherein the first recess and the first protrusion are configured to mate the cover piece and the intermediate piece;
coating the front surface of the intermediate piece with a metalloid;
using the third mold, molding a third resin to form a back piece defining a front surface that defines one of a second recess and a second, the third resin being non-transparent, wherein the second recess or the second protrusion is configured to be mated with at least a first portion of at least one of the intermediate piece and the cover piece; and
forming the radome by mating the cover, intermediate, and back pieces.

12. The method of claim 11, further comprising inserting the cover and intermediate pieces into the third mold prior to molding the third resin.

13. The method of claim 12, wherein molding the third resin to form the back piece includes overmolding a portion of the back piece to form an overmolded edge configured to mate with at least a second portion of at least one of the intermediate piece and the cover piece.

14. The method of claim 11, further comprising inserting the intermediate and back pieces into the first mold prior to molding the first resin.

15. The method of claim 14, wherein molding the first resin to form the cover piece includes overmolding a portion of the cover piece to form an overmolded edge configured to mate with at least a portion of at least one of the intermediate piece and the back piece.

16. The method of claim 11, wherein the metalloid comprises silicon.

17. The method of claim 11, wherein coating the front surface of the intermediate piece with the metalloid includes using physical vapor deposition (PVD).

18. The method of claim 11, wherein the back piece defines an outer edge that defines a thickness that is greater than a thickness defined by a center portion of the back piece.

19. The method of claim 11, further comprising applying a color or a multi-colored graphic to a particular surface of at least one of the cover, intermediate, and back pieces by using a paint or by hot stamping of a film.

20. The method of claim 11, wherein at least one of (i) the first recess, (ii) the first protrusion, and (iii) the second recess or second protrusion corresponds to a symbol associated with a brand of the vehicle.
